(19) United States
(12) Patent Application Publication
(10) Pub. No.: US 2025/0242234 A1
(43) Pub. Date: Jul. 31, 2025

(54) UNIVERSAL CONTROLLER FOR USE WITH EITHER HAND

(71) Applicant: Samsung Electronics Co., Ltd., Suwon-si (KR)

(72) Inventors: Suk Hwan Yoon, San Jose, CA (US); Jinil Kim, San Jose, CA (US)

(21) Appl. No.: 19/002,093

(22) Filed: Dec. 26, 2024

Related U.S. Application Data
(60) Provisional application No. 63/625,886, filed on Jan. 26, 2024.

(51) Int. Cl. A63F 13/24; A63F 13/21

(52) U.S. Cl. CPC A63F 13/24; A63F 13/21; A63F 2300/1018

(57) ABSTRACT

A method includes receiving a user input from a first button or a second button on a hand controller. The first button is at a first location of the hand controller associated with a left hand position, and the second button is at a second location of the hand controller associated with a right hand position. The method also includes determining whether a duration of the user input is greater than a threshold duration and, responsive to a determination that the duration of the user input is greater than the threshold duration, setting the hand controller to be in a left-hand configuration or a right-hand configuration based on which of the first button or the second button the user input is received. In addition, the method includes configuring one or more other buttons on the hand controller based on whether the hand controller is in the left-hand or right-hand configuration.

### CROSS-REFERENCE TO RELATED APPLICATION AND PRIORITY CLAIM

This application claims priority under 35 U.S.C. § 119(e) to U.S. Provisional Patent Application No. 63/625,886 filed on Jan. 26, 2024, which is hereby incorporated by reference in its entirety.

### TECHNICAL FIELD

This disclosure relates generally to input controllers. More specifically, this disclosure relates to a universal controller configurable for use by either hand.

### BACKGROUND

Systems that utilize input controllers for each of a user's hands, such as extended reality (XR) systems, have become increasingly common. However, input controllers often are manufactured and configured to be unique to a user's particular hand, such that the system includes a controller specific to the left hand and another controller specific to the right hand. Therefore, when a user attempts to pick up the controllers to provide inputs to the system, the user must first figure out which controller is for the left hand and which controller is for the right hand. If the user is currently using a headset that covers the user's face, the user may have to remove the headset to visually inspect each controller and then put the headset back on. This is uncomfortable and inconvenient for users because there is not a way to intuitively know for which hand a controller corresponds.

### SUMMARY

This disclosure relates to a universal controller configurable for use by either hand.

In a first embodiment, a method includes receiving a user input from one of a first button or a second button on a hand controller, where the first button is at a first location of the hand controller associated with a left hand position and the second button is at a second location of the hand controller associated with a right hand position. The method also includes determining whether a duration of the user input is greater than a threshold duration. The method further includes, responsive to a determination that the duration of the user input is greater than the threshold duration, setting the hand controller to be in a left-hand configuration or to be in a right-hand configuration based on which of the first button or the second button the user input is received. In addition, the method includes configuring one or more other buttons on the hand controller based on whether the hand controller is in the left-hand configuration or the right-hand configuration.

In a second embodiment, an electronic device includes at least one processing device configured to receive a user input from one of a first button or a second button on a hand controller, where the first button is at a first location of the hand controller associated with a left hand position and the second button is at a second location of the hand controller associated with a right hand position. The at least one processing device is also configured to determine whether a duration of the user input is greater than a threshold duration. The at least one processing device is further configured, responsive to a determination that the duration of the user input is greater than the threshold duration, to set the hand controller to be in a left-hand configuration or to be in a right-hand configuration based on which of the first button or the second button the user input is received. In addition, the at least one processing device is configured to configure one or more other buttons on the hand controller based on whether the hand controller is in the left-hand configuration or the right-hand configuration.

In a third embodiment, a non-transitory machine readable medium includes instructions that when executed cause at least one processor of an electronic device to receive a user input from one of a first button or a second button on a hand controller, where the first button is at a first location of the hand controller associated with a left hand position and the second button is at a second location of the hand controller associated with a right hand position. The non-transitory machine readable medium also includes instructions that when executed cause the at least one processor to determine whether a duration of the user input is greater than a threshold duration. The non-transitory machine readable medium further includes instructions that when executed cause the at least one processor, responsive to a determination that the duration of the user input is greater than the threshold duration, to set the hand controller to be in a left-hand configuration or to be in a right-hand configuration based on which of the first button or the second button the user input is received. In addition, the non-transitory machine readable medium includes instructions that when executed cause the at least one processor to configure one or more other buttons on the hand controller based on whether the hand controller is in the left-hand configuration or the right-hand configuration.

Any one or any combination of the following features may be used with the first, second, or third embodiment. Responsive to a determination that the duration of the user input is less than the threshold duration, a last known configuration setting may be used. The first button and the second button may not protrude from a surface of the hand controller when not pressed and may become recessed when pressed. At least one other function may be caused to be performed when the first button or the second button is pressed after the hand controller is set to be in the left-hand configuration or the right-hand configuration. The at least one other function may be initiated when the first button or the second button is pressed for a duration that is less than the threshold duration. When the hand controller is set to be in the left-hand configuration, the first button may be configured to initiate the at least one other function, and the second button may be configured to be inactive until pressed for a duration that is greater than the threshold duration. When the hand controller is set to be in the right-hand configuration, the second button may be configured to initiate the at least one other function, and the first button may be configured to be inactive until pressed for the duration that is greater than the threshold duration. It may be detected that the hand controller is inactive for a predetermined period of time. In response to the detection that the hand controller is inactive for the predetermined period of time, the hand controller may be set to a neutral setting in which the hand controller is disassociated with the left-hand configuration and the right-hand configuration. An indicator light disposed on the hand controller may be illuminated for a period of time, which can include causing the indicator light to illuminate with a first color indicating that the hand controller is set to be in the left-hand configuration, causing the indicator light to illuminate with a second color indicating that the hand controller is set to be in the right-hand configuration, or causing the indicator light to illuminate with a third color indicating that the hand controller is set to a neutral setting in which the hand controller is disassociated with the left-hand configuration and the right-hand configuration.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device can include a gaming controller for use with a gaming console, or for use with an extended reality (XR), a virtual reality (VR), and/or an augmented reality (AR) headset. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device in accordance with this disclosure;

FIGS. 2A and 2B illustrate an example universal controller in accordance with this disclosure;

FIG. 3 illustrates an example process for configuring a universal controller in accordance with this disclosure;

FIG. 4 illustrates an example process for configuring a universal controller based on detected movement in accordance with this disclosure;

FIG. 5 illustrates an example method for configuring a universal controller in accordance with this disclosure; and

FIG. 6 illustrates an example method for configuring a universal controller based on a non-movement duration in accordance with this disclosure,

### DETAILED DESCRIPTION

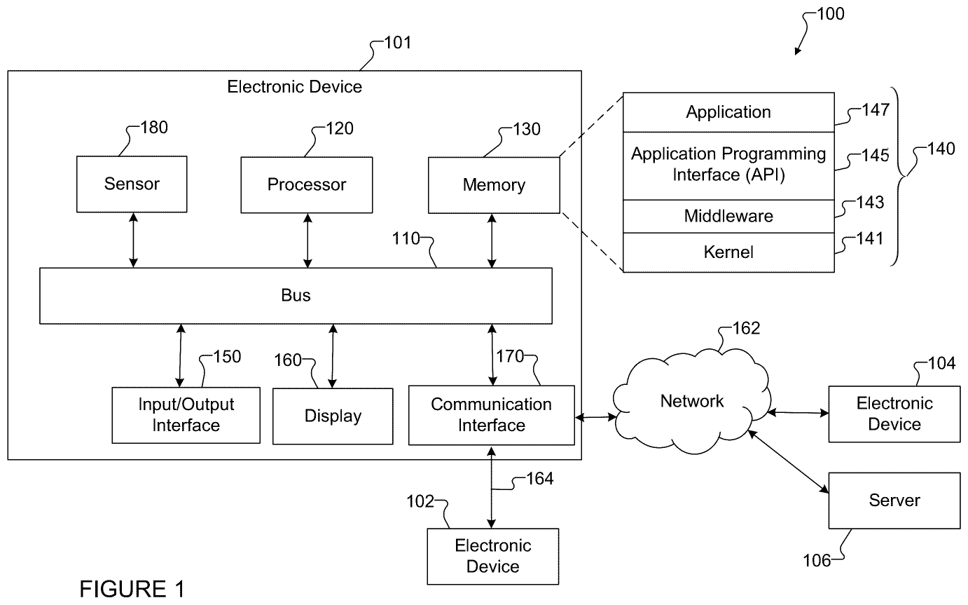

FIGS. 1 through 6, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, systems that utilize input controllers for each of a user's hands, such as extended reality (XR) systems, have become increasingly common. However, input controllers often are manufactured and configured to be unique to a user's particular hand, such that the system includes a controller specific to the left hand and another controller specific to the right hand. Therefore, when a user attempts to pick up the controllers to provide inputs to the system, the user must first figure out which controller is for the left hand and which controller is for the right hand. If the user is currently using a headset that covers the user's face, the user may have to remove the headset to visually inspect each controller and then put the headset back on. This is uncomfortable and inconvenient for users because there is not a way to intuitively know for which hand a controller corresponds.

This disclosure provides for a universal hand controller and associated systems and methods that allow the universal hand controller to be configurable for, and used by, either hand. Various embodiments of this disclosure provide for allowing a selection to be made via the universal hand controller as to which of a user's left hand or right hand is to be used for operating the universal hand controller. Inputs can be provided on the universal hand controller at convenient locations such that a user can select a hand to be used via muscle memory without having to look at the universal hand controller. Additionally, various embodiments of this disclosure provide for automatically reassigning functions to one or more inputs (such as one or more buttons or keys) on the universal hand controller based on which hand is selected. Various embodiments of this disclosure also provide methods of clearing a selected hand based on, for example, an elapsed period of time where no input is provided using the universal hand controller. Thus, the universal hand controller and associated systems and methods of this disclosure make it so that a user does not need to figure out which of two controllers is a right hand controller or a left hand controller. Rather, a user can simply grab either one of two universal hand controllers with either hand and use the universal hand controller for that hand.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to a universal controller for an extended reality (XR) device or for another suitable application.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to a universal controller for an XR device or other suitable application. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first external electronic device 102, a second external electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals. For example, the universal controller (such as a hand controller), described with respect to this disclosure may be the first external electronic device 102, and the electronic device 101 may be a device communicatively connected to the universal controller to process inputs transmitted by the universal controller, such as a gaming console, PC, or XR device.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can include a wearable device or an electronic device-mountable wearable device (such as an HMD). When the electronic device 101 is mounted in the first external electronic device 102 (such as the HMD), the electronic device 101 can communicate with the first external electronic device 102 through the communication interface 170. The electronic device 101 can be directly connected with the first external electronic device 102 to communicate with the first external electronic device 102 without involving with a separate network. The electronic device 101 can also be an augmented reality wearable device, such as eyeglasses, that include one or more imaging sensors.

The first and second external electronic devices 102, 104 and the server 106 each can be a device of the same or a different type from the electronic device 101. According to certain embodiments of this disclosure, some components of the electronic device 101 may not be included in the first and second external electronic devices 102, 104 and the server 106, such as the display 160. According to certain embodiments of this disclosure, the server 106 includes a group of one or more servers. Also, according to certain embodiments of this disclosure, all or some of the operations executed on the electronic device 101 can be executed on another or multiple other electronic devices (such as the first and second external electronic devices 102, 104 or server 106). Further, according to certain embodiments of this disclosure, when the electronic device 101 should perform some function or service automatically or at a request, the electronic device 101, instead of executing the function or service on its own or additionally, can request another device (such as first and second external electronic devices 102, 104 or server 106) to perform at least some functions associated therewith. The other electronic device (such as first and second external electronic devices 102, 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the second external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform various operations related to a universal controller for an extended reality device. For example, the server 106 may receive and process inputs provided by the universal controller and transmitted, such as via another device connected to the universal controller like a gaming console or XR headset, to cause changes to the game state based on the controller inputs.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

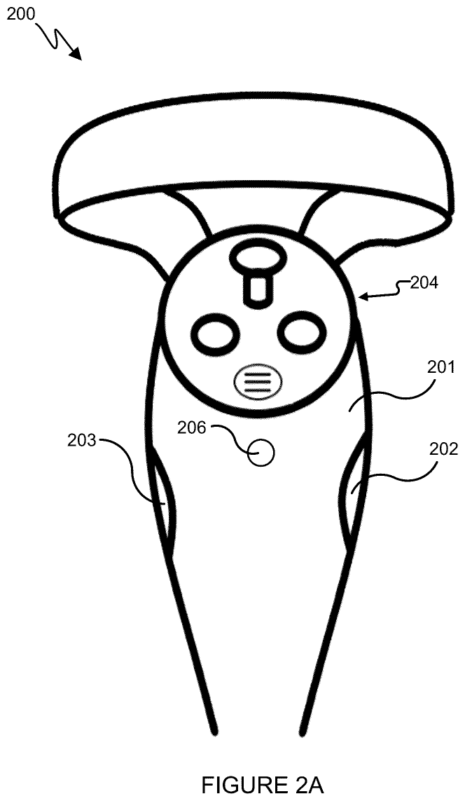

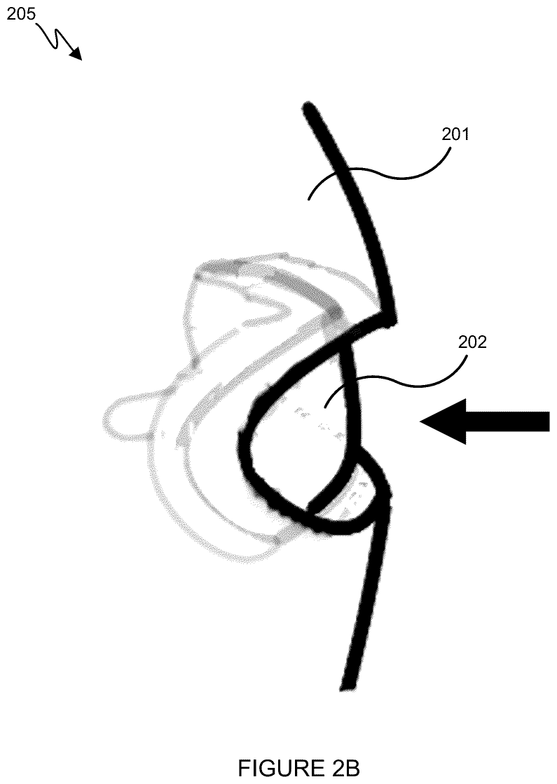

FIGS. 2A and 2B illustrate an example universal controller 200 in accordance with this disclosure. More specifically, FIG. 2A illustrates a front view of the universal controller 200, and FIG. 2B illustrates a portion 205 of the universal controller 200 including a hand selection input button. For case of explanation, the universal controller 200 shown in FIGS. 2A and 2B is described as being implemented using the first external electronic device 102 in the network configuration 100 of FIG. 1. However, the universal controller 200 shown in FIGS. 2A and 2B could represent or be used with any other suitable device(s) and in any other suitable system(s).

It will be understood that, in various implementations, a user may operate two instances of the universal controller 200, such as when the user is using a universal controller 200 in each hand when operating an XR device or engaging in other tasks. As shown in FIG. 2A, the universal controller 200 includes a main body portion 201. The main body portion 201 of the universal controller 200 includes a first button 202 and a second button 203 disposed at positions on the main body portion 201, such as on opposing sides of the main body portion 201. One of the first button 202 and the second button 203 can be configured to indicate, when pressed, that the controller is to be used with a user's left hand. Another of the first button 202 and the second button 203 can be configured to indicate, when pressed, that the controller is to be used with a user's right hand. For example, the first button 202 can be configured to indicate, when pressed, that the universal controller 200 is to be used with a user's left hand. The first button 202 can be positioned at a first location of the universal controller 200, as shown in FIG. 2A, that is easily accessible when the universal controller 200 is held in the user's left hand but perhaps not the user's right hand. Similarly, the second button 203 can be configured to indicate, when pressed, that the universal controller 200 is to be used with a user's right hand. The second button 203 can be positioned at a second location the universal controller 200, as shown in FIG. 2A, that is easily accessible when the universal controller 200 is held in the user's right hand but perhaps not the user's left hand.

In various embodiments, control of the hand selection using the universal controller 200 can be based on an input type. For example, in some embodiments, the first and second buttons 202, 203 may operate to select a hand to be used based on a longer press of the corresponding first or second button 202, 203. In such embodiments, when the first button 202 is long-pressed, the controller can be configured as the left hand controller. When the second button 203 is long-pressed, the controller can be configured as the right hand controller. This can be based on determining if a duration of the button press exceeds a threshold duration.

In various embodiments of this disclosure, once the universal controller 200 is configured as a right-hand or a left-hand controller, one or more other buttons of the universal controller 200 can be configured accordingly. For example, as shown in FIG. 2A, the universal controller 200 can include various other inputs 204, such as other buttons, joysticks, etc., for controlling one or more applications running on a device communicatively linked to the universal controller 200 (such as the electronic device 101). For example, a button of the other inputs 204 comfortably accessible by a user's left-hand thumb when the universal controller 200 is gripped in the left hand, but that may not be comfortably accessible when the universal controller 200 is gripped in the right hand, may be assigned a functionality (such as causing a character to jump in a game) when the first button 202 is used to assign the universal controller 200 to be in a left-hand configuration. As another example, when the second button 203 is used to assign the universal controller 200 to be in a right-hand configuration, a different button of the other inputs 204 comfortably accessible to a user's right-hand thumb can be assigned the functionality.

In some embodiments, a shorter press of one of the first or second buttons 202, 203 can also be assigned functionality after a hand configuration is selected. For example, when the first button 202 is long-pressed to assign the universal controller 200 to the left hand, the first button 202 can be configured as a general button for performing other functions, such as selecting a menu item, triggering game items, etc. In these cases, the second button 203 can, in various embodiments, be set to have a null function when short-pressed, at least until the second button 203 is long-pressed to make a hand configuration change or the hand configuration is reset. Similarly, when the second button 203 is long-pressed to assign the universal controller 200 to the right hand, the second button 203 can be configured as a general button for performing other functions, such as selecting a menu item, triggering game items, etc. In those cases, the first button 202 can, in various embodiments, be set to have a null function when short-pressed, at least until the first button 202 is long-pressed to make a hand configuration change or the hand configuration is reset.

As shown in FIG. 2B, in various embodiments, the buttons for providing the hand determination, such as first and second buttons 202, 203, can be seated at the same level as the handle surface when they are not pressed (not shown in FIG. 2B). That is, the first and second buttons 202, 203 may not be protruding from the main body portion 201 when not pressed. When one of the first or second buttons 202, 203 is pressed as shown in FIG. 2B, the first button 202 and the second button 203 can move inward to prevent accidental pressing of the first or second buttons 202, 203, such as by a user's palm, while still allowing for a user to intentionally press one of the first or second buttons 202, 203 using a longer press or a shorter press.

In some embodiments, the universal controller 200 can include an indicator light 206 that indicates a current configuration setting to the user. For example, the indicator light 206 can be illuminated, at least for a period of time, to show one of a first color (such as a blue light) indicating that the hand controller is set in the left-hand configuration, a second color (such as a green light) indicating that the hand controller is set in the right-hand configuration, or a third color (such as a red light) indicating that the hand controller is set to a neutral setting in which the hand controller is disassociated with the left-hand configuration and the right-hand configuration. In various embodiments, the indicator light 206 need not be on all the time. In some cases, for instance, the indicator light 206 may be turned on only when movement is detected to save power while the controller is not being used, such as when a user grabs and/or moves the controller. The detection of movement may occur in any suitable manner, such as by using one or more sensors 180 like a touch sensor, a gyroscopic sensor, etc.

Although FIGS. 2A and 2B illustrate one example of a universal controller 200, various changes may be made to FIGS. 2A and 2B. For example, various components and/or functions of the components in FIGS. 2A and 2B may be combined, further subdivided, replicated, or rearranged according to particular needs. Also, one or more additional components and/or associated functions may be included if needed or desired. In addition, hand controllers for controlling devices such as XR devices can come in a variety of form factors, shapes, and button configurations. It will be understood that the universal controller 200 shown here is but one example of a controller in accordance with this disclosure and that other controllers of differing form factors, shapes, and button configurations can be used. As a particular example, instead of the main body portion 201 being a shaft that a user grips, the universal controller 200 could be in a fingerless glove shape or other shape, and the first and second buttons 202, 203 and the inputs 204 could be rearranged as desired to ergonomically allow for selection by a user's fingers.

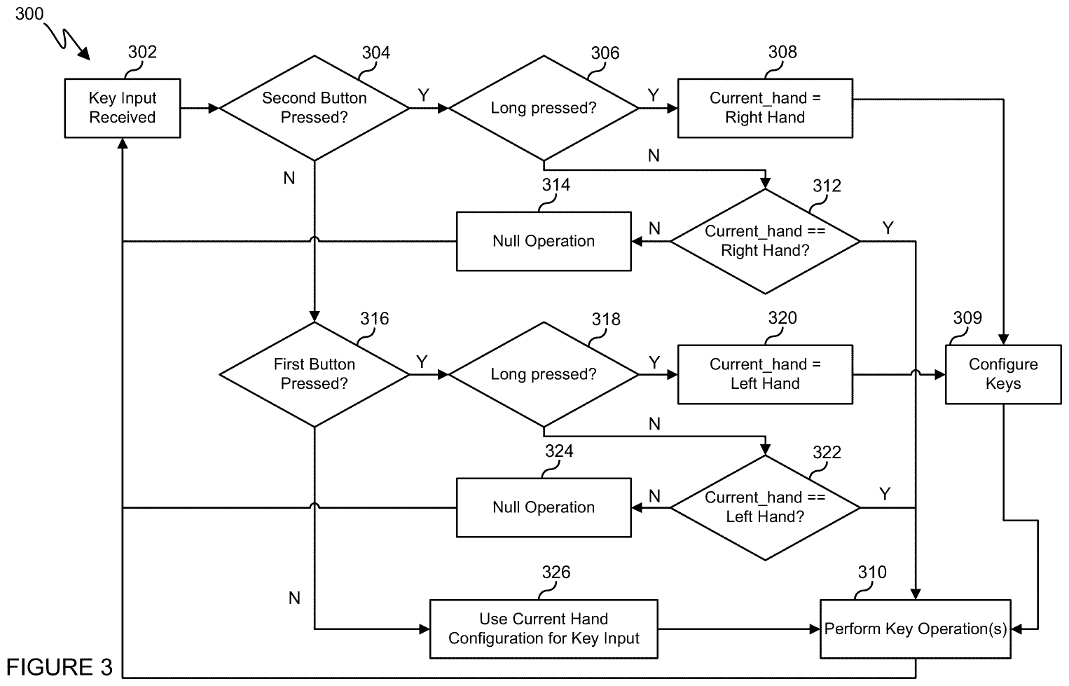

FIG. 3 illustrates an example process 300 for configuring a universal controller in accordance with this disclosure. For case of explanation, the process 300 shown in FIG. 3 is described as involving the use of the electronic device 101 in the network configuration 100 of FIG. 1. However, the process 300 shown in FIG. 3 may be used with any other suitable electronic device (such as the server 106) or a combination of devices (such as the electronic device 101 and the server 106) and in any other suitable system(s). In various embodiments, the process 300 can be controlled by the electronic device 101 acting as an XR device, gaming console, or other device, with the first external electronic device 102 being the universal controller providing inputs to the electronic device 101. In other embodiments, the universal controller can independently perform the process 300.

As shown in FIG. 3, the process 300 includes, at step 302, receiving a button input. The button input may be received by the electronic device 101 and provided by a universal controller, such as the universal controller 200. For example, the button input(s) received at step 302 could be an input to configure the universal controller to be in a left-hand configuration or a right-hand configuration using either a first button or a second button, such as the first and second buttons 202, 203 described with respect to FIGS. 2A and 2B.

At step 304, it is determined whether the button input received at step 302 indicates that the second button was pressed. If so, at step 306, it is determined whether the second button was long-pressed. If so, at step 308, the universal controller is assigned the right-hand configuration, and one or more buttons, keys, or other inputs of the universal controller are configured accordingly at step 309. At step 310, one or more further operations can be performed using the configured buttons and/or other inputs. For example, face buttons on the controller more comfortably accessible by a user's right hand can be assigned certain functions, while the second button can be configured to perform a particular function in response to a shorter press. In some embodiments, the first button can be set as inactive while the controller is in the right-hand configuration.

If, at step 306, it is determined that the second button was not long-pressed, at step 312, it is determined whether the universal controller is already set to the right-hand configuration. If so, a function related to a shorter press of the second button can be performed as or as part of the operations at step 310. If, at step 312, it is determined that the universal controller is not set to the right-hand configuration, the input received at the second button can be processed as a null operation at step 314.

If, at step 304, it is determined that the second button is not pressed, at step 316, it is determined whether the button input received at step 302 indicates that the first button was pressed. If so, at step 318, it is determined whether the first button was long-pressed. If so, at step 320, the universal controller is assigned the left-hand configuration, and one or more buttons, keys, or other inputs of the universal controller are configured accordingly at step 309. At step 310, one or more further operations can be performed using the configured buttons and/or other inputs. For example, face buttons on the controller more comfortably accessible by a user's left hand can be assigned certain functions, while the first button can be configured to perform a particular function in response to a short press. In some embodiments, the second button can be set as inactive while the controller is in the left-hand configuration.

If, at step 316, it is determined that the first button was not long-pressed, at step 322, it is determined whether the universal controller is already set to the left-hand configuration. If so, a function related to a shorter press of the first button can be performed as or as part of the operations at step 310. If, at step 322, it is determined that the universal controller is not set to the left-hand configuration, the input received at the first button can be processed as a null operation at step 324.

If, at step 316, it is determined that the first button was not pressed, this can indicate that another button or controller input other than the first and second buttons was indicated by the received input. If so, at step 326, the current hand configuration (such as left-hand configuration or right-hand configuration) is used for the input, and one or more operations are carried out at step 310. If a neutral configuration is currently set at step 326, no operation may be performed at step 310. The process 300 can loop from step 310 back to step 302 to receive and process further input.

Although FIG. 3 illustrates one example of a process 300 for configuring a universal controller, various changes may be made to FIG. 3. For example, while shown as a series of steps, various steps in FIG. 3 could overlap, occur in parallel, occur in a different order, or occur any number of times (including zero times). As a particular example, although step 316 is illustrated as being contingent on a determination that the second button was not pressed at step 304, in various embodiments, the process 300 can simply detect whether the first or second button was pressed and proceed accordingly as shown in FIG. 3.

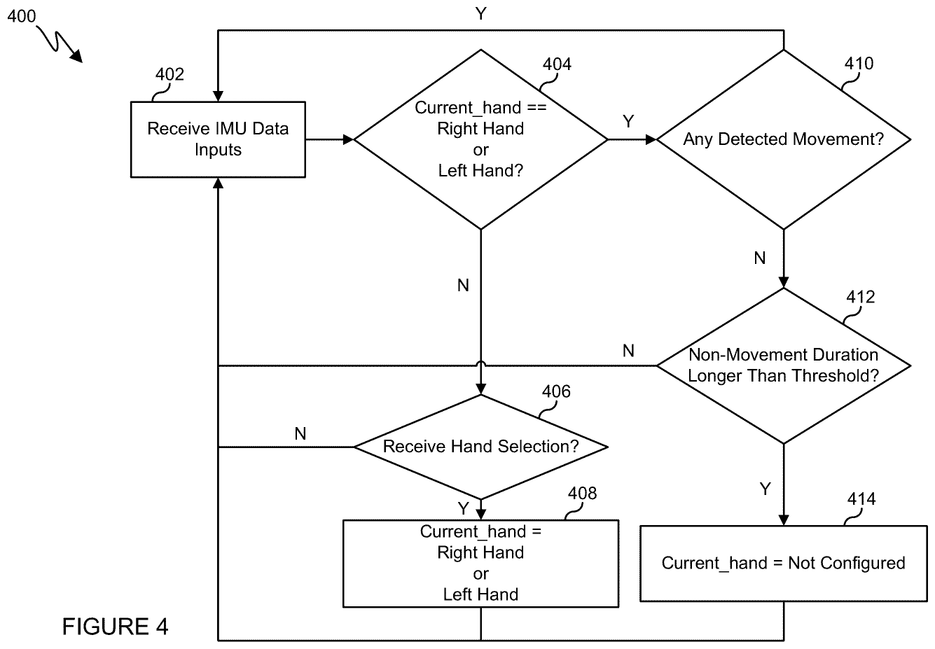

In various embodiments, after the controller is configured as a right or left-handed controller, if the controller is recognized as not moving for a certain time (such as 1 minute, 5 minutes, 30 minutes, etc.) by using IMU or other data, the configuration can be reset to a neutral or “not configured” configuration. For instance, FIG. 4 illustrates an example process 400 for configuring a universal controller based on detected movement in accordance with this disclosure. For ease of explanation, the process 400 shown in FIG. 4 is described as involving the use of the electronic device 101 in the network configuration 100 of FIG. 1. However, the process 400 shown in FIG. 4 may be used with any other suitable electronic device (such as the server 106) or a combination of devices (such as the electronic device 101 and the server 106) and in any other suitable system(s). In various embodiments, the process 400 can be controlled by the electronic device 101 acting as an XR device, gaming console, or other device, with the first external electronic device 102 being the universal controller providing inputs to the electronic device 101. In other embodiments, the universal controller 200 can independently perform the process 400.

As shown in FIG. 4, at step 402, IMU data inputs are received. For example, the electronic device 101 may receive IMU data provided by the universal controller 200. At step 404, it is determined whether the controller is currently configured in either the left-hand configuration or the right-hand configuration. If not, at step 406, it is determined if a hand selection is received, such as is described with respect to FIGS. 2A, 2B, and 3 above. If not, the process 400 loops back to step 402. If so, at step 408, the controller is configured in either the left-hand or right-hand configuration based on the received selection, and the process loops back to step 402.

If, at step 404, it is determined that the controller is already configured in either the left-hand configuration or the right-hand configuration, at step 410, it is determined if any movement is detected. If so, the process 400 loops back to step 402 to receive further IMU data inputs. If, however, at step 410 it is determined that no movement is detected based on the IMU data inputs, at step 412, it is determined whether a duration of the non-movement of the controller is longer than a threshold duration. As noted above, the threshold duration can be set to any suitable duration, such as 1 minute, 5 minutes, 30 minutes, etc.

If it is determined at step 412 that the non-movement duration is shorter than the threshold duration, the process 400 loops back to step 402. If it is determined at step 412 that the non-movement duration is longer than the threshold duration, at step 414, the controller can be set to a neutral configuration in which it is not assigned to either the left or right hand. That is, after being moved to the neutral configuration, the hand configuration for the controller can be set again by long-pressing one of the buttons (such as first button 202 or second button 203) when the controller is picked up again for use.

Although FIG. 4 illustrates one example of a process 400 for configuring a universal controller based on detected movement, various changes may be made to FIG. 4. For example, while shown as a series of steps, various steps in FIG. 4 could overlap, occur in parallel, occur in a different order, or occur any number of times (including zero times).

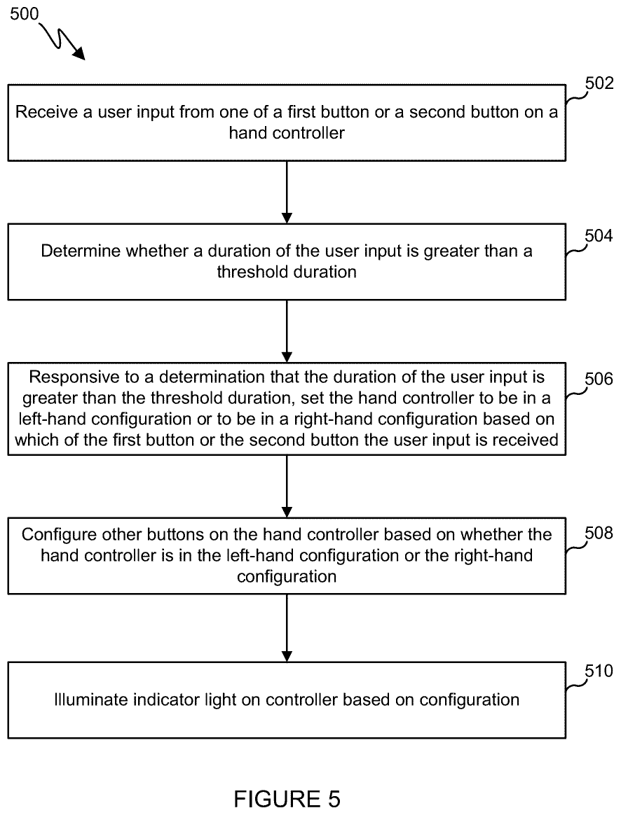

FIG. 5 illustrates an example method 500 for configuring a universal controller in accordance with this disclosure. For case of explanation, the method 500 shown in FIG. 5 is described as involving the use of the electronic device 101 in the network configuration 100 of FIG. 1. However, the method 500 shown in FIG. 5 may be used with any other suitable electronic device (such as the server 106) or a combination of devices (such as the electronic device 101 and the server 106) and in any other suitable system(s). In various embodiments, the method 500 can be controlled by the electronic device 101 acting as an XR device, gaming console, or other device, with the first external electronic device 102 being the universal controller providing inputs to the electronic device 101. In other embodiments, the universal controller can independently perform the method 500.

At step 502, a user input is received from one of a first button or a second button on a hand controller, such as the universal controller 200. This can include receiving at the hand controller a selection of the first button or the second button and transmitting, by the hand controller, an indication of the selection to the electronic device 101. In other cases, the hand controller can internally process the inputs according to the method 500. As described in this disclosure, in some embodiments, the first button is at a first location of the hand controller associated with a left hand position, and the second button is at a second location of the hand controller associated with a right hand position. As described in this disclosure, in some embodiments, the first button and the second button do not protrude from a surface of the hand controller when not pressed and become recessed when pressed.

At step 504, it is determined whether a duration of the user input is greater than a threshold duration. This can include determining, based on a detected button press duration, whether the button was pressed for a duration exceeding the threshold. In some embodiments, the hand controller can make a determination of whether the press was a longer press that exceeds the threshold and instruct the electronic device 101 accordingly. Also, in some embodiments, responsive to a determination that the duration of the user input is less than the threshold duration, a last known configuration for the hand controller setting can be used.

At step 506, responsive to a determination that the duration of the user input is greater than the threshold duration, the hand controller is set to be in a left-hand configuration or to be in a right-hand configuration based on which of the first button or the second button receives the user input. At step 508, one or more other buttons on the hand controller are configured based on whether the hand controller is in the left-hand configuration or the right-hand configuration. As described in this disclosure, once the hand controller is configured, the user can use the hand controller to perform various functions with respect to the application and/or device being manipulated using the hand controller.

As also described in this disclosure, in various embodiments, at least one other function can be caused to be performed when the first button or the second button is pressed after the hand controller is set to be in the left-hand configuration or the right-hand configuration. In some embodiments, the at least one other function is initiated when the first button or the second button is pressed for a duration that is less than the threshold duration. For example, in some embodiments, when the hand controller is set to be in the left-hand configuration, the first button is configured to initiate the at least one other function, and the second button is configured to be inactive until pressed for a duration that is greater than the threshold duration. When the hand controller is set to be in the right-hand configuration, the second button is configured to initiate the at least one other function, and the first button is configured to be inactive until pressed for the duration that is greater than the threshold duration.

In various embodiments, such as that described with respect to FIG. 4, the electronic device 101 can detect that the hand controller is inactive for a predetermined period of time and, in response to the detection that the hand controller is inactive for the predetermined period of time, set the hand controller to a neutral setting in which the hand controller is disassociated with the left-hand configuration and the right-hand configuration. At step 510, an indicator light on the hand controller, such as the indicator light 206, may be illuminated based on the set configuration of the hand controller. For example, in various embodiments, the indicator light disposed on the hand controller can be illuminated to be one of a first color indicating that the hand controller is set to be in the left-hand configuration, a second color indicating that the hand controller is set to be in the right-hand configuration, or a third color indicating that the hand controller is set to a neutral setting in which the hand controller is disassociated with the left-hand configuration and the right-hand configuration.

Although FIG. 5 illustrates one example of a method 500 for configuring a universal controller, various changes may be made to FIG. 5. For example, while shown as a series of steps, various steps in FIG. 5 could overlap, occur in parallel, occur in a different order, or occur any number of times (including zero times).

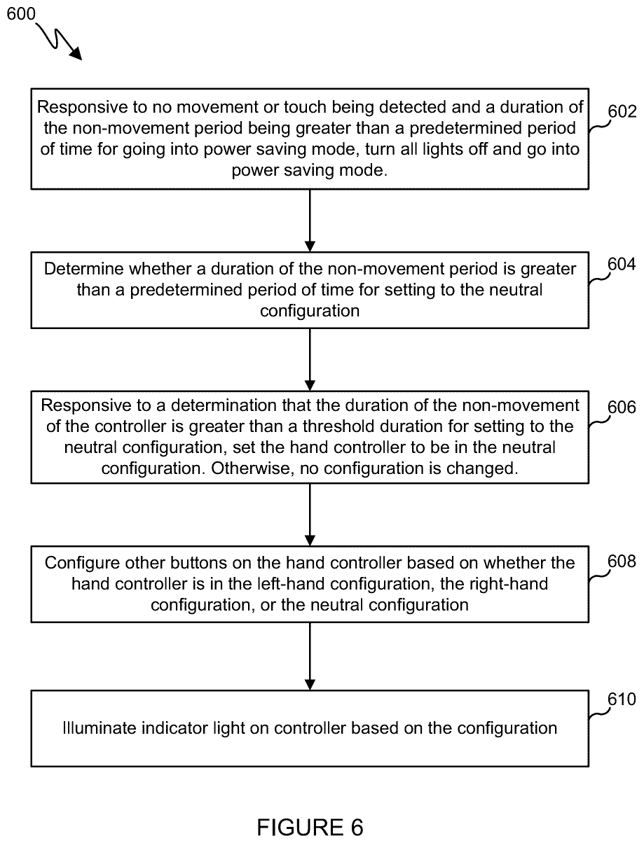

FIG. 6 illustrates an example method for configuring a universal controller based on a non-movement duration in accordance with this disclosure. For case of explanation, the method 600 shown in FIG. 6 is described as involving the use of the electronic device 101 in the network configuration 100 of FIG. 1. However, the method 600 shown in FIG. 6 may be used with any other suitable electronic device (such as the server 106) or a combination of devices (such as the electronic device 101 and the server 106) and in any other suitable system(s). In various embodiments, the method 600 can be controlled by the electronic device 101 acting as an XR device, gaming console, or other device, with the first external electronic device 102 being the universal controller providing inputs to the electronic device 101. In other embodiments, the universal controller can independently perform the method 600.

As described in this disclosure, in various embodiments, a universal controller can be set to be in a neutral configuration when not used for a certain period of time, i.e., when no movement is detected using the universal controller. As shown in FIG. 6, at step 602, responsive to no movement or touch being detected, and a duration of the non-movement period being greater than a predetermined period of time for going into a power saving mode, all lights on the controller can be turned off and the controller can go into a power saving mode. At step 604, it is determined whether a duration of the non-movement period is greater than a predetermined period of time for setting to the neutral configuration. For example, it may be that the threshold duration for entering the power saving mode at step 602 is less than the duration for setting the controller to the neutral configuration. At step 606, responsive to a determination that the duration of the non-movement of the controller is greater than a threshold duration for setting to the neutral configuration, set the hand controller to be in the neutral configuration. Otherwise, no configuration is changed if the threshold is not exceeded.

At step 608, other buttons on the hand controller are configured based on whether the hand controller is in the left-hand configuration, the right-hand configuration, or the neutral configuration, as described in this disclosure. At step 610, an indicator light on the controller, such as indicator light 206, is illuminated based on the set configuration. For example, in various embodiments, the indicator light disposed on the hand controller can be illuminated to be one of a first color (e.g., blue) indicating that the hand controller is set to be in the left-hand configuration, a second color (e.g., green) indicating that the hand controller is set to be in the right-hand configuration, or a third color (e.g., red) indicating that the hand controller is set to a neutral setting in which the hand controller is disassociated with the left-hand configuration and the right-hand configuration.

Although FIG. 6 illustrates one example of a method 600 for configuring a universal controller, various changes may be made to FIG. 6. For example, while shown as a series of steps, various steps in FIG. 6 could overlap, occur in parallel, occur in a different order, or occur any number of times (including zero times).

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
receiving a user input from one of a first button or a second button on a hand controller, wherein the first button is at a first location of the hand controller associated with a left hand position, and wherein the second button is at a second location of the hand controller associated with a right hand position;
determining whether a duration of the user input is greater than a threshold duration;
responsive to a determination that the duration of the user input is greater than the threshold duration, setting the hand controller to be in a left-hand configuration or to be in a right-hand configuration based on which of the first button or the second button the user input is received; and
configuring one or more other buttons on the hand controller based on whether the hand controller is in the left-hand configuration or the right-hand configuration.

2. The method of claim 1, further comprising:
responsive to a determination that the duration of the user input is less than the threshold duration, using a last known configuration setting.

3. The method of claim 1, wherein the first button and the second button do not protrude from a surface of the hand controller when not pressed and become recessed when pressed.

4. The method of claim 1, further comprising:
causing at least one other function to be performed when the first button or the second button is pressed after the hand controller is set to be in the left-hand configuration or the right-hand configuration.

5. The method of claim 4, wherein the at least one other function is initiated when the first button or the second button is pressed for a duration that is less than the threshold duration.

6. The method of claim 5, wherein:
when the hand controller is set to be in the left-hand configuration, the first button is configured to initiate the at least one other function, and the second button is configured to be inactive until pressed for a duration that is greater than the threshold duration; and
when the hand controller is set to be in the right-hand configuration, the second button is configured to initiate the at least one other function, and the first button is configured to be inactive until pressed for the duration that is greater than the threshold duration.

7. The method of claim 1, further comprising:
detecting that the hand controller is inactive for a predetermined period of time; and
in response to the detection that the hand controller is inactive for the predetermined period of time, setting the hand controller to a neutral setting in which the hand controller is disassociated with the left-hand configuration and the right-hand configuration.

8. The method of claim 1, further comprising:
illuminating, for a period of time, an indicator light disposed on the hand controller,
wherein illuminating the indicator light comprises one of:
causing the indicator light to illuminate with a first color indicating that the hand controller is set to be in the left-hand configuration;
causing the indicator light to illuminate with a second color indicating that the hand controller is set to be in the right-hand configuration; or
causing the indicator light to illuminate with a third color indicating that the hand controller is set to the neutral setting in which the hand controller is disassociated with the left-hand configuration and the right-hand configuration.

9. An electronic device comprising:
at least one processing device configured to:
receive a user input from one of a first button or a second button on a hand controller, wherein the first button is at a first location of the hand controller associated with a left hand position, and wherein the second button is at a second location of the hand controller associated with a right hand position;
determine whether a duration of the user input is greater than a threshold duration;
responsive to a determination that the duration of the user input is greater than the threshold duration, set the hand controller to be in a left-hand configuration or to be in a right-hand configuration based on which of the first button or the second button the user input is received; and
configure one or more other buttons on the hand controller based on whether the hand controller is in the left-hand configuration or the right-hand configuration.

10. The electronic device of claim 9, wherein the at least one processing device is further configured, responsive to a determination that the duration of the user input is less than the threshold duration, to use a last known configuration setting.

11. The electronic device of claim 9, wherein the first button and the second button do not protrude from a surface of the hand controller when not pressed and become recessed when pressed.

12. The electronic device of claim 9, wherein the at least one processing device is further configured to cause at least one other function to be performed when the first button or the second button is pressed after the hand controller is set to be in the left-hand configuration or the right-hand configuration.

13. The electronic device of claim 12, wherein the at least one other function is initiated when the first button or the second button is pressed for a duration that is less than the threshold duration.

14. The electronic device of claim 13, wherein:
when the hand controller is set to be in the left-hand configuration, the first button is configured to initiate the at least one other function and the second button is configured to be inactive until pressed for a duration that is greater than the threshold duration; and
when the hand controller is set to be in the right-hand configuration, the second button is configured to initiate the at least one other function and the first button is configured to be inactive until pressed for the duration that is greater than the threshold duration.

15. The electronic device of claim 9, wherein the at least one processing device is further configured to:
detect that the hand controller is inactive for a predetermined period of time; and
in response to the detection that the hand controller is inactive for the predetermined period of time, set the hand controller to a neutral setting in which the hand controller is disassociated with the left-hand configuration and the right-hand configuration.

16. The electronic device of claim 9, wherein:
the at least one processing device is further configured to illuminate, for a period of time, an indicator light disposed on the hand controller; and
to illuminate the indicator light, the at least one processing device is configured to one of:
cause the indicator light to illuminate with a first color indicating that the hand controller is set to be in the left-hand configuration;
cause the indicator light to illuminate with a second color indicating that the hand controller is set to be in the right-hand configuration; or
cause the indicator light to illuminate with a third color indicating that the hand controller is set to the neutral setting in which the hand controller is disassociated with the left-hand configuration and the right-hand configuration.

17. A non-transitory machine readable medium comprising instructions that when executed cause at least one processor of an electronic device to:
receive a user input from one of a first button or a second button on a hand controller, wherein the first button is at a first location of the hand controller associated with a left hand position, and wherein the second button is at a second location of the hand controller associated with a right hand position;
determine whether a duration of the user input is greater than a threshold duration;
responsive to a determination that the duration of the user input is greater than the threshold duration, set the hand controller to be in a left-hand configuration or to be in a right-hand configuration based on which of the first button or the second button the user input is received; and
configure one or more other buttons on the hand controller based on whether the hand controller is in the left-hand configuration or the right-hand configuration.

18. The non-transitory machine readable medium of claim 17, further comprising instructions that when executed cause the at least one processor, responsive to a determination that the duration of the user input is less than the threshold duration, to use a last known configuration setting.

19. The non-transitory machine readable medium of claim 17, further comprising instructions that when executed cause the at least one processor to cause at least one other function to be performed when the first button or the second button is pressed after the hand controller is set to be in the left-hand configuration or the right-hand configuration,
wherein the at least one other function is initiated when the first button or the second button is pressed for a duration that is less than the threshold duration.

20. The non-transitory machine readable medium of claim 17, further comprising instructions that when executed cause the at least one processor to:
detect that the hand controller is inactive for a predetermined period of time; and
in response to the detection that the hand controller is inactive for the predetermined period of time, set the hand controller to a neutral setting in which the hand controller is disassociated with the left-hand configuration and the right-hand configuration.
